(19) United States
(12) Patent Application Publication
(10) Pub. No.: US 2019/0136620 A1
(43) Pub. Date: May 9, 2019

(54) STRETCHABLE LADDER

(71) Applicant: NEW-TEC INTEGRATION (XIAMEN) CO., LTD., Xiamen, Fujian (CN)

(72) Inventor: Luhao LENG, Xiamen, Fujian (CN)

(73) Assignee: NEW-TEC INTEGRATION (XIAMEN) CO., LTD., Xiamen, Fujian (CN)

(21) Appl. No.: 16/096,570

(22) PCT Filed: Apr. 26, 2017
(86) PCT No.: PCT/CN2017/082013

§ 371 Date: Oct. 25, 2018

(30) Foreign Application Priority Data
May 3, 2016 (CN) 201620388810.3

(51) Int. Cl. E06C 1/12; E06C 7/42; E06C 7/08

(52) U.S. Cl. CPC E06C 1/125; E06C 7/082; E06C 7/42

(57) ABSTRACT

A stretchable ladder, having inner leg bar and outer leg bar, the side edge of the outer leg bar forming an opening. The outer leg bar is sleeved on the inner leg bar, with the inner leg bar and the outer leg bar being relatively slidable. The ladder has a lock structure for locking the inner leg bar and for preventing the inner leg bar from separating from the outer leg bar. The lock structure is disposed at the outer leg bar, and is hookable to the inner leg bar, so as to make the inner leg bar embedded in the outer leg bar.

### TECHNICAL FIELD

The present invention relates to a stretchable ladder, particularly to a support leg of a ladder.

### BACKGROUND OF THE INVENTION

A stretchable ladder comprises two inner legs, an inner cross bar connecting the two inner leg bars, two outer leg bars, an outer cross bar connecting the two outer leg bars; the outer leg is sleeved on the inner leg, the inner leg is slidable with respect to the outer leg to achieve stretching function. The inner leg and the outer leg are slidable relatively, the reason that they don't separate from each other is the outer cross bar, that is to say, the outer cross bar pulls the two outer legs at the same time. Once the outer leg and the outer cross bar loose, the inner leg and the outer leg will separate. Therefore, the connecting of the inner leg and the outer leg of existing stretchable ladder is not stable and reliable. The connecting of the outer leg and the outer cross bar should be strong enough, otherwise they separate. In another word, the structure of the ladder needs to improve.

### SUMMARY OF THE INVENTION

The present invention is provided with a stretchable ladder, which overcomes the disadvantages of the existing known technology. The technical proposal of the present invention is that:

A stretchable ladder, comprising inner leg bar and outer leg bar, the inner leg bar is a closed frame, the outer leg bar comprises a bottom plate and two side plates, two side plates are symmetrically disposed at the two ends of the bottom plate, the section of the outer leg bar is [ shaped or the extending of the shape, the side edge of the outer leg bar forms an opening; the outer leg bar is sleeved on the inner leg bar, the inner leg bar and the outer leg bar are relatively slidable, wherein further comprising a lock structure used to lock the inner leg bar and to prevent the inner leg bar separating from the outer leg bar, the lock structure is disposed in the outer leg bar.

In another preferred embodiment, the lock structure comprises a guiding block and a sliding groove, the guiding block is disposed at the inner side face of the side plate, the external surface of the inner leg bar is disposed with the sliding groove, the guiding block is slidably disposed in the sliding groove.

In another preferred embodiment, it comprises two guiding blocks symmetrically disposed at the two side plates.

In another preferred embodiment, the lock structure comprises a stop plate, the stop plate is disposed at the end of the side plate away from the bottom plate.

In another preferred embodiment, the lock structure comprises a lock hook, the lock hook is disposed at the inner side of the bottom plate, the inner leg bar is disposed with a curve hook, the lock hook is slidably locked to the curve hook.

In another preferred embodiment, it comprises two lock hooks.

In another preferred embodiment, the lock structure and the outer leg bar are integrally formed; the inner leg bar is a closed hollow tube.

Compared to the existing known technology, the technical proposal of the present invention has advantages as follows:

The lock structure is disposed at the outer leg bar, the lock structure can hook the inner leg bar, making the inner leg bar embedded in the outer leg bar, thus reducing the risk of the inner leg bar and the outer leg bar separating from each other, thus improving the stability of the ladder. In the case of same safety factor, the welding area of the outer leg bar and the cross bar can be reduced, thus reducing the welding cost.

### BRIEF DESCRIPTION OF THE DRAWINGS

The present invention will be further described in accordance with the drawings and the embodiments.

FIG. 1 illustrates a sectional diagram of a stretchable leg of a stretchable ladder of a first embodiment.

FIG. 2 illustrates a schematic diagram of an outer leg bar of a stretchable ladder of the present invention.

FIG. 3 illustrates a sectional diagram of a stretchable leg of a stretchable ladder of a second embodiment.

FIG. 4 illustrates a sectional diagram of a stretchable leg of a stretchable ladder of a third embodiment.

### DETAILED DESCRIPTION OF THE EMBODIMENTS

### The First Embodiment

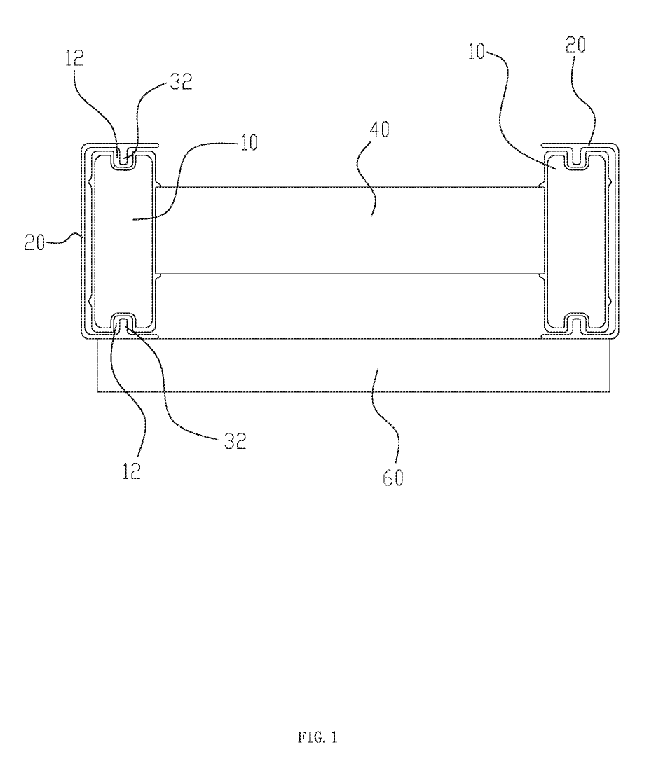

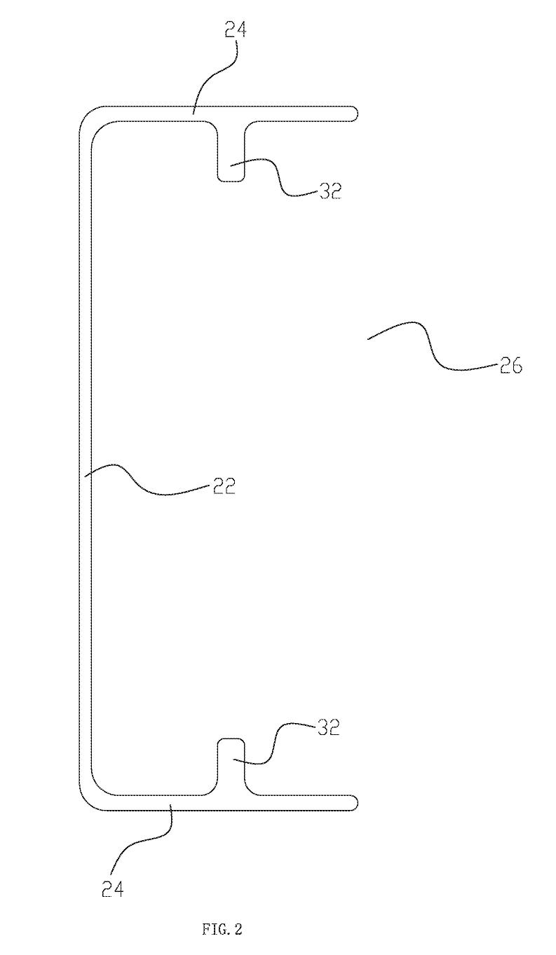

Please referring to FIG. 1 and FIG. 2, the stretchable ladder comprises two inner leg bars 10, an inner cross bar 40 connecting the two inner leg bars 10, two outer leg bars 20, an outer cross bar 60 connecting the two outer leg bars 20; the two outer leg bars 20 are respectively slidably connected to the two inner leg bars 10. The stretchable leg of the stretchable ladder of the present invention comprises the inner leg bar 10 and the outer leg bar 20. The section of the outer leg bar 20 is [ shaped, the outer leg bar 20 comprises a bottom plate 22 and two side plates 24, two side plates 24 are symmetrically disposed at the two ends of the bottom plate 22, the side edge of the outer leg bar forms an opening 26. The inner leg bar 10 is a closed hollow tube. The outer leg bar 20 is sleeved on the inner leg bar 10, the inner leg bar 10 and the outer leg bar 20 can slide relatively.

This embodiment further comprises a lock structure disposed at the outer leg bar 20 used to lock the inner leg bar 10 and to prevent the inner leg bar 10 separating from the outer leg bar 20 along the opening 26. The lock structure and the outer leg bar 20 are integrally formed.

The lock structure comprises two guiding blocks 32 symmetrically disposed at the inner side face of the two side plates 24, the external surface of the inner leg bar 10 is disposed with a sliding groove 12, the guiding block 32 is slidably disposed in the sliding groove 12.

### The Second Embodiment

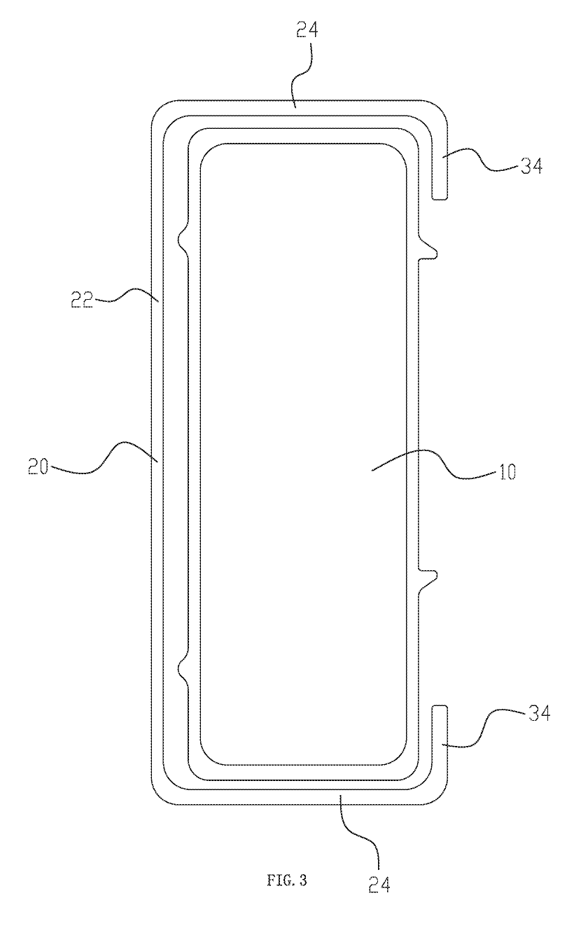

Referring to FIG. 3, this embodiment differs from the first embodiment in that: the lock structure comprises two stop plate 34, the stop plates 34 are respectively disposed at the two side plates 24. The stop plate 34 is disposed at the end of the side plate 24 away from the bottom plate 22. The cross section of the outer leg bar 20 is C shaped.

### The Third Embodiment

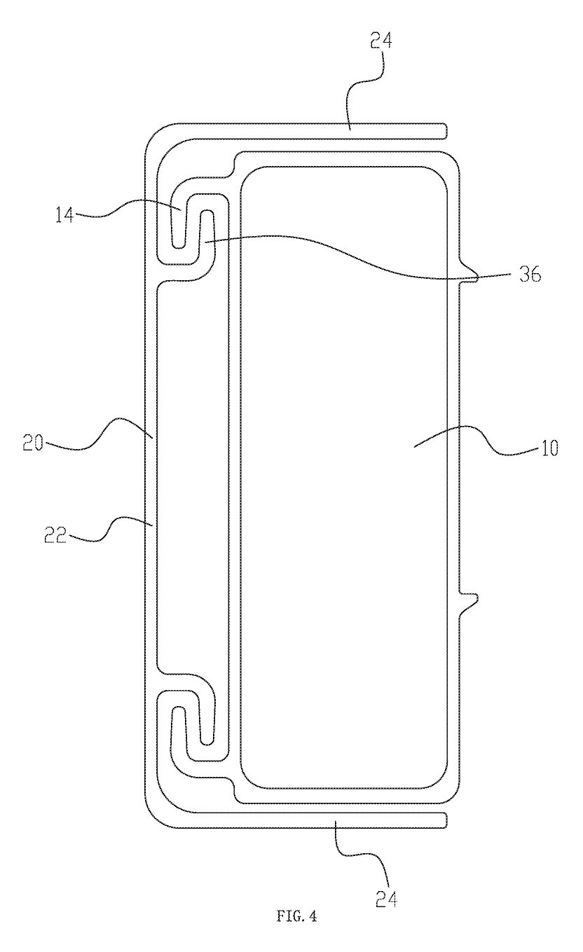

Referring to FIG. 4, this embodiment differs from the first embodiment in that: the lock structure comprises two lock hooks 36 disposed at the inner side of the bottom plate 22, the inner leg bar 10 is disposed with a curve hook 14 corresponding to the lock hook, the lock hook 36 is slidably locked to the curve hook 14. The lock hook 36 and the curve hook 14 are symmetrical.

### INDUSTRIAL APPLICABILITY

The present invention is provided that the leg tube of the stretchable ladder is disposed with a lock structure, making the slidable connecting of the inner leg and the outer leg, the present invention has strong strength and simple structure.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A stretchable ladder, comprising inner leg bar and outer leg bar, the inner leg bar is a closed frame, the outer leg bar comprises a bottom plate and two side plates, two side plates are symmetrically disposed at the two ends of the bottom plate, the section of the outer leg bar is [ shaped or the extending of the shape, the side edge of the outer leg bar forms an opening; the outer leg bar is sleeved on the inner leg bar, the inner leg bar and the outer leg bar are relatively slidable, wherein further comprising a lock structure used to lock the inner leg bar and to prevent the inner leg bar separating from the outer leg bar, the lock structure is disposed in the outer leg bar.

2. The stretchable ladder according to claim 1, wherein the lock structure comprises a guiding block and a sliding groove, the guiding block is disposed at the inner side face of the side plate, the external surface of the inner leg bar is disposed with the sliding groove, the guiding block is slidably disposed in the sliding groove.

3. The stretchable ladder according to claim 2, wherein comprising two guiding blocks symmetrically disposed at the two side plates.

4. The stretchable ladder according to claim 1, wherein the lock structure comprises a stop plate, the stop plate is disposed at the end of the side plate away from the bottom plate.

6. The stretchable ladder according to claim 1, wherein the lock structure comprises a lock hook, the lock hook is disposed at the inner side of the bottom plate, the inner leg bar is disposed with a curve hook, the lock hook is slidably locked to the curve hook.

7. The stretchable ladder according to claim 6, wherein comprising two lock hooks.

8. The stretchable ladder according to claim 1, wherein the lock structure and the outer leg bar are integrally formed; the inner leg bar is a closed hollow tube.
